(19) United States
(12) Patent Application Publication
(10) Pub. No.: US 2007/0256603 A1
(43) Pub. Date: Nov. 8, 2007

(54) CEMENTITIOUS COMPOSITION FOR USE IN ELEVATED TO FULLY SATURATED SALT ENVIRONMENTS

(75) Inventors: Carey Heinbigner, Moose Jaw (CA); Murray Dean Schultz, Moose Jaw (CA); Devon Kyle Hill, Regina (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: The Mosaic Company, Minneapolis, MN (US)

(21) Appl. No.: 11/381,691

(22) Filed: May 4, 2006

(51) Int. Cl. C04B 18/06; C04B 14/00; C04B 28/10; C04B 16/00

(52) U.S. Cl. 106/706; 106/811; 106/705; 106/804; 106/718

(57) ABSTRACT

A cementitious composition made by providing a brine solution comprising water and salt; mixing the brine solution with a salt sequestering agent; adding a cementitious base material and mixing to form the cementitious composition. The salt sequestering agent is conveniently a zeolite.

The invention is in the field of cementitious compositions and in particular such compositions for use in elevated salt environments.

### BACKGROUND

Cementitious compositions are used in a wide variety of industries for a wide variety of uses. Cementitious compositions can be mixed such that the resulting cement product has a wide variety of properties, depending on the use. The type and proportion of cementitious base material that is used in a cementitious composition will, to a large extent, dictate the strength of the cement product that forms when the cementitious composition cures. In the majority of cases the cementitious base material will include at least some amount of a Portland cement, and may include varying proportions of waste products to reduce costs, such as fly ash, slag, silica fume, rice hull ash, or like pozzolanic material. The Portland cement adds significant strength to the resulting cement product.

In some applications however, the desired strength of the resulting cement product is quite low. For example when stabilizing soil to support construction or the like, a cementitious composition may be injected as a grout into the soil. It is known to use a cementitious composition where the cementitious base material contains no actual Portland cement, but only fly ash or the like.

Similarly, in the mining industry, excavation of material results in the formation of underground caverns, which accumulate considerable loose rubble that falls from walls and roofs thereof. It is desirable to stabilize the rubble, and one method of stabilization involves the use of cementitious compositions to bind rubble together, a process known in the art as “grouting”. Cementitious compositions are also injected as a grout into cracks or fissures in underground formations to stabilize the walls and roofs of caverns formed during the mining process.

As the cementitious composition is most conveniently produced at the mine site, it is common practice to use available water from underground sources in the mixing of the composition. However, depending on the chemical composition of the water, the rubble used as fill and the surrounding substratum, the final cement product can have widely varying structural properties, particularly where elevated salt levels are present.

Several problems in producing cementitious compositions have been identified in the art. One common problem is the fluid loss from the uncured grout into the surrounding material. Fluid loss results in improper curing of the cementitious composition, which can reduce the strength of the final material. Fluid loss also significantly reduces penetration of grout due to the viscosity increase, and can damage formations that accept the lost fluid under pressurized conditions. A weakened cement product that may not suitable for the particular application may also result.

Prior art solutions have been developed to reduce fluid loss from cementitious compositions. A common solution is to use various compounds as fluid loss control agents. For example, the inclusion of various modified potato starches have been shown to be effective in reducing fluid loss in cementitious compositions. The starch bonds with the water to control and minimize fluid loss, and allow for better curing, increased penetration, and a stronger finished product.

However, there is a limit to the effectiveness of using starch alone as a fluid loss control agent, and starch alone will not solve the problem of fluid loss under all circumstances. For example, when water sources with high salinity are used in the making of the cement grout mixture, water loss is not adequately controlled by starch addition.

Groundwater sources in the vicinity of a potash mine are frequently high in salt content due to the surrounding mineral formations. Frequently in areas like these, it is either impractical or impossible to import fresh water for use in making cement grout. In addition, even if it were possible to obtain a source of fresh water, rubble and the surrounding substratum both contain salts that are easily dissolved by the water in the cementitious composition, increasing the salinity of the aqueous component which in turn leads to water loss, poor penetration and curing and a weak cement product such that extensive additional drilling or like measures are required to compensate.

Salt content of the aqueous component of a cementitious composition causes other problems as well. As little as 10% salt has been shown to alter thickening time and increase viscosity as well as significantly increasing fluid loss. Cementitious compositions containing salt brine also have highly variable set characteristics, again compromising the proper curing of the cementitious composition.

In order to fully penetrate a fissure with a substantially homogeneous cement grout mixture, the viscosity of the cement grout mixture must be low enough to facilitate pumping using conventional means. “Bleed” is an undesirable tendency for particulate components of a cement grout mixture to separate from the fluid component. Again, various prior art additives have been found to be useful in preventing grout bleed. However, as with the problem of fluid loss, high salt environments cause excessive bleed in cementitious compositions due to limited availability of suitable viscosity control additives, making them problematic for use in underground locations. Brine is also known as being a very effective dispersant, which further reduces the Low Shear Rate Viscosity (LSRV) of the slurry, again causing additional potential for bleed.

Salt in underground formations can pose problems in other industries as well. For example, in the oil industry, once a well is drilled a steel casing is generally installed in the well bore and a cementitious composition is pumped into the annulus between the well casing and the walls of the bore to produce a more durable and permanent structure as the well is put into long term production. Oil wells frequently penetrate through salt-bearing substrata, and the presence of salt in the surrounding formation has been long-known to affect the performance of cement compositions used in well casings.

### SUMMARY OF THE INVENTION

It is an object of the present invention to provide a cementitious composition and product that overcome problems in the prior art.

In a first embodiment the invention provides a cementitious composition made by providing a brine solution comprising water and salt; mixing the brine solution with a salt sequestering agent; adding a cementitious base material and mixing to form the cementitious composition.

In a second embodiment the invention provides a cementitious composition suitable for use in a high salt environment, the composition comprising water, a salt sequestering agent, and a cementitious base material.

Zeolite is known for it's ability to preferentially sequester Sodium and Potassium ions, rather than Calcium, Magnesium, Iron, and other cations. It is thus contemplated that an agent that prefers to sequester Sodium and Potassium ions over cations could be used for the purpose of sequestering salt.

Diatomaceous earth or a zeolitized diatomaceous earth may also be used as a salt sequestering agent. Crown Ether is another known salt sequestering agent which is expected to work as effectively as zeolite for this purpose, but is currently too expensive to use for this application.

The cementitious composition may also include other additives, operative to improve the workability of the composition and strength of the finished cement product.

The invention is especially adapted for use in elevated to fully saturated salt environments. The salt may be in the form of sodium chloride or potassium chloride although other types of salts may be compatible with the present invention.

The grout composition as described above can be applied to a void such as found in rubble in an underground cavern left over after the extraction of material from a mine, or subterranean cracks and fissures. The high salt environment can be present for example in a potash mine or oil well.

### DETAILED DESCRIPTION

As discussed above the use of cementitious compositions in underground high salt environments presents special problems. Of these, the separation of fluid, typically aqueous fluid, from the particulate components of the cementitious composition, a process known as bleed, as well as fluid loss to the surrounding formation due to salt induced movement of fluid can result in the inability of a cementitious composition to properly cure and attain the strength needed to be useful. In addition, grout bleed and loss of fluid affects grout viscosity. This can be problematic when it is necessary to pump the grout into a desired location such as subterranean cracks or fissures for formation stabilization, into caverns created during mining operations, or for use in the construction of drill hole casing as is done in the oil and gas industry.

The present invention provides a cementitious composition, adapted for use in high salt environments. The cementitious composition is made by mixing an aqueous component with a salt sequestering agent prior to adding the cementitious base material and any fluid loss control agent.

The salt sequestering agent is conveniently zeolite. Zeolites are a class of hydrated alumino-silicate minerals that have a porous structure. Zeolites are comprised of interlocking tetrahedrons of SiO₄ and AlO₄ the crystals having a net negative charge. The lattice arrangement of the zeolite crystal is of such a size and arrangement that it readily accommodates a wide variety of positive ions, including sodium, potassium, calcium and magnesium. Zeolites are used commercially as molecular sieves and are useful for ion exchange, filtering and removing odors or toxins from aqueous solutions. Zeolites are also used previously in the concrete industry, particularly in the production of warm mix asphalt concrete. The inclusion of zeolites helps decrease temperature levels during manufacture and laying of this type of concrete, thus reducing the amount of energy required to produce this type of concrete, as well as to reduce release of vapors and aerosols during the production and curing process.

However, the present invention is novel in the use of zeolites to maintaining the desired properties of a cement grout composition in a high salt environment. Specifically, zeolite is operative as a sodium and potassium salt sequestering agent. The inclusion of zeolite into a cementitious composition made with a high salt brine as the aqueous component functions to sequester the salt.

Fluid loss additives can work more effectively, thus keeping the water in the cementitious composition, and thus limiting fluid loss to the surrounding material.

Other salt sequestering agents could also be suitable for use in the present invention. For example, diatomaceous earth is added to cement compositions as a cement extender. Diatomaceous earth or a zeolitized diatomaceous earth could function as a salt sequestering agent in cementitious compositions. The amount of salt sequestering agent used may vary according to the desired properties of the final composition, but in general the addition of zeolite between 1 and 20% by weight is used, primarily dependant on the salt saturation of the brine. It is contemplated that significantly higher concentrations in the order of 50% could be used as well without adversely affecting the composition.

A fluid loss control agent such as a starch can be included to limit fluid loss from the cementitious composition. The amount of starch can vary according to the desired properties of grout viscosity, tendency to bleed and final strength, but generally starch added in amounts between 0.1 and 2% by weight will be effective, and amounts as high as 10% would be present in some circumstances. Commercially available starch products such as Drilstar®P are well known as fluid loss control agents and it is expected that other fluid loss control agents may function as well as starch.

Other components may also be added to the cementitious composition in order to enhance certain properties of the composition. For example, fly ash is commonly used in the concrete industry in place of a portion of the cement component. The composition may also include a conventional dispersant to affect properties such as flowability, curing time, early and ultimate strength, and the like. Dispersants can also reduce the water required in the composition and may enhance pumpability. For example, adding a dispersant such as Glenium® 3030 in an amount between 0.01 and 2% would be beneficial to the properties of the grout composition upon mixing and during application.

Other rheology adjustment and control additives may also be included in the composition such as, accelerators, retarders, viscosity modifiers, and like additives that are known for use in cementitious compositions. Many commercially available additives are not suited to high or fully saturated brine, but the addition of the salt sequestering agent allows for use of many of these additives.

The grout composition of the present invention is well adapted for use in high to fully saturated salt environments. Most commonly the salt will be either sodium chloride or potassium chloride, although the term salt is not intended to be limiting in any way. The source of the salt may either be from the water source used in the formulation of the cementitious composition, such as brackish water, or a more saturated brine, or may arise as the dissolution of salts present in the region to which the grout is applied. For example, the use of a cementitious composition in an underground salt formation such as a potash mine or a drill hole extending through a salt dome would solubilize salts from the surrounding substratum and result in a high salt environment.

Additionally, conventional viscosity modifying additives including Whelan, Xanthan, Guar, and other Polysaccharide gums which are not normally effective for high salt brine environments can now be used more effectively. The composition of the present invention allows for use of relatively inexpensive rheology control additives, instead of more expensive and complicated specialty additives presently formulated for high salt environments. The viscosity additives are useful for controlling washout, reducing bleed or free water, and controlling the required penetration. There are minimal viscosity modifiers available for high salt brine based grouts containing cements due to flocculation and incompatibility.

Example A provides one embodiment of the cementitious composition of the invention, as well as data from tests of compositions actually produced in accordance with the present invention as described herein.

The embodiments described herein are illustrative in nature only, and are not intended to limit the scope to which the composition or method of the invention may be applied.

### EXAMPLE A

Laboratory scale and full scale field trials were performed to evaluate the properties of a cementitious mixture including Zeolite as a salt sequestering agent. The ingredients were mixed in the order below.

| | | |
|---|---|---|
| 420 | mL | NaCl saturated brine as the aqueous component, which also |
| | | includes KCl, and multiple other cationic salts. |
| 4 | mL | Glenium 3030 Dispersant |
| 140 | gm | British Columbia Clinoptilolite Zeolite |
| 230 | gm | Type 10 Inland Cement |
| 450 | gm | Boundary Dam Power Station Fly Ash |
| 180 | ml | Drilstar P Starch (prehydrated in brine @ 8% concentration of |
| | | starch weight by brine volume = 14 grams) |

The properties of a grout composition as described in Example A were tested. Marsh cone time for the grout composition on initial mixing was 45 seconds. Bleed values ranged from 2.5 to 5%, and API fluid loss in a 400 ml sample of the grout composition subjected to 100 p.s.i. ranged from 0 to 30 mls in 30 minutes.

Gel strength was measured as 1 Pa, while the plastic viscosity and yield point of the initial grout composition was 0.021 and 5.3 Pa respectively. Initial gelation of the grout occurred within 1 hour, and final gelation occurred within 23 hr. Final gelation was the point at which the grout composition could not be pumped. The grout composition was initially set within 3.25 to 3.75 days, and final setting observed at around 5 days.

It has also been confirmed that cement slurry accelerators including Calcium Chloride can be used to accelerate the gelation and final set time of the cement slurry as required by the application. Accelerators can be successfully used to achieve rapid set times required for oilwell style casing cementing operations where formation closure can damage casings during curing.

After setting of the grout, the compressive strength of the finished grout product was determined (See Table 1).

TABLE 1
Compressive Strength of Cured Grout

| Curing Time | Compressive Strength |
|---|---|
| 7 days | 150 psi/1.0 MPa |
| 14 days | 335 psi/2.3 MPa |
| 16 days | 455 psi/3.1 MPa |
| 21 days | 600 psi/4.1 MPa |

When used in a grouting application such as stabilizing a mine site, or when used with a rubble backfill, or when injected into subterranean cracks or fissures as a method of stabilization of a formation, it is generally considered that a compressive strength of 150 psi is satisfactory for many mining applications due to complete confinement in all directions, and provided no entrained air or void spaces exist in the final product. Thus, the data obtained in a testing a grout composition made in accordance with the present invention indicate that a grout of sufficient strength is produced.

Initial strengths significantly higher than these values can be obtained by increasing the cement component and reducing the brine component. The strength values shown above are for a cementitious composition, with a Brine to Powder ratio of approximately 0.7:1, with the cementitious/pozzolanic powder addition being 28% cement, 55% Fly ash, and 17% Zeolite, where all compressive strength samples were cured in brine

When measuring proportions using a high salt brine as the aqueous component of a cementitious composition, the density of the aqueous component can be significantly greater than water. For example a liter of brine may weigh 1100-1200 grams, instead of 1000 gm. For purposes of mixing cementitious compositions with brine using the methods of the present invention it is convenient to use a proportion that uses a weight of any particular ingredient per liter of brine.

Thus for example adding Zeolite to a brine solution at a proportion of 25% by weight would involve adding 250 grams of Zeolite to one liter of brine. The optimum proportion of zeolite will depend on the proportions of salt in the aqueous solution, but it is also contemplated that adding zeolite to a level above that required to sequester the salt present will not adversely affect the cementitious composition, such that proportions of 1% to 50% by volume of brine will typically be used.

The cementitious base material in Example A is a mixture of about one part Portland cement to two parts fly ash. It will be apparent to those skilled in the art that these proportions will vary widely and that the cementitious base material could be 100% fly ash in some situations and 100% Portland cement in others.

It is important to note that the salt sequestering zeolite is added to the brine prior to adding the cementitious base material. In situations where the aqueous component is relatively salt free water where the cementitious composition is to be used in an environment such as an oil well casing where the salinity will increase after the cementitious composition is mixed, the order of mixing will not be critical.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of preparing a cementitious composition comprising:
providing a brine solution comprising water and salt;
mixing the brine solution with a salt sequestering agent;
adding a cementitious base material and mixing to form the cementitious composition.

2. The method of claim 1, wherein the salt in the brine solution is a monovalent salt.

3. The method of claim 2, wherein the salt in the monovalent salt is one of sodium chloride and potassium chloride.

4. The method of claim 1, wherein the salt sequestering agent is selected from the group consisting of a zeolite, a diatomaceous earth, a zeolitized diatomaceous earth or combinations thereof.

5. The method of claim 1, wherein the salt sequestering agent is present in an amount between 1 and 50% by weight.

6. The method of claim 1, wherein the cementitious base material comprises at least one of a Portland cement and a pozzolanic material.

7. The method of claim 6, wherein the pozzolanic material comprises fly ash.

8. The method of claim 1, and further comprising adding a fluid loss control agent.

9. The method of claim 8, wherein the fluid loss control agent comprises a starch.

10. The method of claim 9, wherein the starch is present in an amount of 0.1 to 10.0% by weight.

11. The method of claim 1, and further comprising adding a dispersant.

12. The method of claim 11, wherein the dispersant is present in an amount between 0.01 and 2% volume to weight.

13. A cementitious composition suitable for use in a high salt environment, the composition comprising water, a salt sequestering agent, and a cementitious base material.

14. The cementitious composition of claim 13, wherein the salt sequestering agent is selected from the group consisting of a zeolite, a diatomaceous earth, a zeolitized diatomaceous earth, or combinations thereof.

15. The cementitious composition of claim 13, wherein the salt sequestering agent is present in an amount between 1 and 50% by weight.

16. The cementitious composition of claim 13, wherein the cementitious base material comprises at least one of a Portland cement and a pozzolanic material.

17. The cementitious composition of claim 13, and comprising a fluid loss control agent.

18. The cementitious composition of claim 17, wherein the fluid loss control agent comprises a starch.

19. The cementitious composition of claim 13, and further comprising a dispersant.
